(19) United States
(12) Patent Application Publication
(10) Pub. No.: US 2025/0139460 A1
(43) Pub. Date: May 1, 2025

(54) METHOD FOR TRAINING CONTRASTIVE LEARNING MODEL, ACQUIRING OPTIMIZATION ITEM, AND PUSHING INFORMATION

(71) Applicant: Hangzhou Alibaba International Internet Industry Co., Ltd., Hangzhou (CN)

(72) Inventors: Lyuxing Zhu, Hangzhou (CN); Kexin Zhang, Shenzhen (CN); Hao Chen, Hangzhou (CN); Chao Wei, Hangzhou (CN); Weiru Zhang, Hangzhou (CN); Haihong Tang, Hangzhou (CN); Xiu Li, Shenzhen (CN)

(21) Appl. No.: 18/888,871

(22) Filed: Sep. 18, 2024

(30) Foreign Application Priority Data
Oct. 26, 2023 (CN) 202311405086.1

(51) Int. Cl. G06N 5/01

(52) U.S. Cl. CPC G06N 5/01

(57) ABSTRACT

A method for training a contrastive learning model, acquiring an optimization item, and pushing information includes: obtaining sample data including first category information and query information; predicting a correlation between the first category information and the query information using the contrastive learning model; establishing a loss function based on the prediction results, wherein the loss function is configured to characterize accuracy of the prediction results; optimizing the loss function based on a semantic relationship between the first category information and second category information, wherein the first category information and the second category information correspond to different semantic information in a category tree, and the semantic relationship is related to relative positions of the first category information and the second category information within the category tree; and training the contrastive learning model based on the optimized loss function.

### CROSS-REFERENCE TO RELATED APPLICATIONS

This application claims priority to Chinese Patent Application No. 202311405086.1, filed with the China National Intellectual Property Administration on Oct. 26, 2023, and entitled “Method for Training Contrastive Learning Model, Acquiring Optimization Item, and Pushing Information,” which is incorporated herein by reference in its entirety.

### TECHNICAL FIELD

The present disclosure relates to the field of artificial intelligence technology, and more particularly, to a method for training a contrastive learning model, acquiring an optimization item, and pushing information.

### BACKGROUND

Query classification plays a crucial role in e-commerce, with the goal of assigning user queries to appropriate categories within a category tree. Contrastive learning is a commonly used optimization method for category prediction tasks. However, current contrastive learning methods classify query information based on information from leaf categories within the category tree, resulting in relatively low classification accuracy.

### SUMMARY

In a first aspect, the embodiments of the present disclosure provide a method for training a contrastive learning model. The method includes: obtaining sample data including first category information and query information; predicting a correlation between the first category information and the query information using the contrastive learning model; establishing a loss function based on the prediction results, wherein the loss function is configured to characterize accuracy of a prediction result; optimizing the loss function based on a semantic relationship between the first category information and the second category information, where the first category information and the second category information correspond to different semantic information within a category tree, and the semantic relationship is related to relative positions of the first category information and the second category information within the category tree; and training the contrastive learning model based on the optimized loss function.

In a second aspect, the embodiments of the present disclosure provide a method for acquiring an optimization item for use in the training the contrastive learning model as described in the first aspect. The method includes: obtaining first category information from first sample data and second category information from second sample data; determining a semantic relationship between the first category information and the second category information, where the semantic relationship is related to the relative positions of the first category information and the second category information within the category tree; and generating an optimization item based on the semantic relationship, where the optimization item is used to optimize the loss function of the contrastive learning model.

In a third aspect, the embodiments of the present disclosure provide an information pushing method. The method includes: obtaining target query information input by a user; predicting the target category information to which the target query information belongs using a contrastive learning model; wherein the contrastive learning model is trained using the training method of the contrastive learning model as described in the first aspect; and pushing object information of at least one object under the target category information to the user.

In a fourth aspect, the embodiments of the present disclosure provide a computer-readable storage medium, on which a computer program is stored. When executed by a processor, the program implements the method according to any of the embodiments of the present disclosure.

In a fifth aspect, the embodiments of the present disclosure provide a computer device, which includes a memory, a processor, and a computer program stored in the memory and executable by the processor, wherein the processor, when executing the program, implements the method according to any of the embodiments of the present disclosure.

In the embodiments of the present disclosure, the semantic relationships between different category information are utilized to optimize the loss function. Since the semantic relationships are related to the relative positional relationships of different category information within the category tree, the optimized loss function based on these semantic relationships is used to train the contrastive learning model. This allows the trained model to perform category prediction based on the position of the category information within the category tree. This training method effectively leverages the hierarchical information of the category tree, thereby significantly improving the classification accuracy of the contrastive learning model for query information.

It should be understood that the above general description and the detailed description that follows are merely exemplary and explanatory, and are not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the technical solutions of the present disclosure.

FIG. 1 is a schematic diagram of the application scenario according to an embodiment of the present disclosure.

FIG. 2 is a schematic diagram of the application scenario of query classification in e-commerce according to an embodiment of the present disclosure.

FIG. 3 is a schematic diagram of the category tree according to an embodiment of the present disclosure.

FIG. 4 is a flowchart of the training method of the contrastive learning model according to an embodiment of the present disclosure.

FIG. 5 is a schematic diagram of the structure of the contrastive learning model according to an embodiment of the present disclosure.

FIG. 6 is a flowchart of the method for acquiring an optimization item according to an embodiment of the present disclosure.

FIG. 7 is a flowchart of the information push method according to an embodiment of the present disclosure.

### DETAIL DESCRIPTION OF THE EMBODIMENTS

The exemplary embodiments are described in detail herein, and their examples are illustrated in the accompanying drawings. In the following description, whenever a reference is made to the drawings, the same or similar elements are denoted by the same reference numerals across different figures, unless otherwise indicated. The embodiments described in the following exemplary embodiments do not represent all possible embodiments consistent with the present disclosure. Instead, they are merely examples of devices and methods consistent with some aspects of the present disclosure as detailed in the appended claims.

The terminology used in the present disclosure is for the purpose of describing particular embodiments only and is not intended to limit the present disclosure. As used in the present disclosure and the appended claims, the singular forms “a,” “an,” “the,” and “this” are intended to include the plural forms as well, unless the context clearly indicates otherwise. It should also be understood that the term “and/or” as used herein refers to and includes any and all possible combinations of one or more of the associated listed items. Additionally, the term “at least one” as used herein indicates any combination of one or more of the items, including at least two of the items.

It should be understood that although the terms first, second, third, etc., may be used in the present disclosure to describe various information, such information should not be limited to these terms. These terms are only used to distinguish information of the same type from one another. For example, without departing from the scope of the present disclosure, the first information may also be referred to as the second information, and similarly, the second information may be referred to as the first information. Depending on the context, the term “if,” as used herein, may be interpreted as “when,” “while,” or “in response to determining.”

To enable those skilled in the art to better understand the technical solutions in the embodiments of the present disclosure, and to make the above objectives, features, and advantages of the embodiments of the present disclosure more apparent and comprehensible, the technical solutions in the embodiments of the present disclosure will be described in further detail below in conjunction with the accompanying drawings.

The goal of query classification is to assign user queries to the appropriate categories using a hierarchical product category classification method. FIG. 1 illustratively shows a schematic diagram of an application scenario of the present disclosure. A user can provide query information through input or selection on the client side. The client generates a query request based on the query information provided by the user and sends the query request to the server. The server can parse the query information from the query request, retrieve at least one category related to the query information, and push the information of objects within that at least one category to the client.

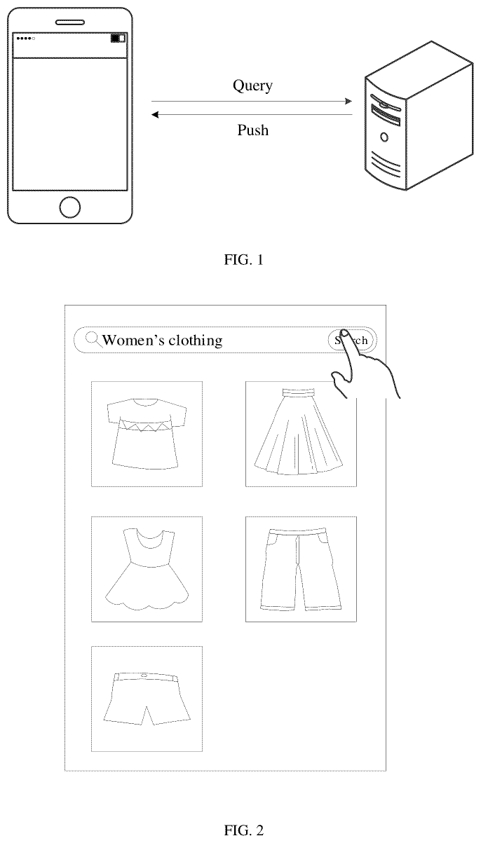

FIG. 2 illustratively shows an application scenario of query classification in e-commerce. The query information input by the user may be keywords. The client may include a search box where the user can enter keywords, such as “women's clothing.” The client may also include a confirmation component, and after the user clicks the confirmation component, the client can submit the query request to the server. The server, in response to the query request, can search for categories related to “women's clothing” and push the information of objects within the corresponding categories to the client for display. As shown in FIG. 2, the categories displayed on the client may include women's T-shirts, skirts, dresses, women's trousers, women's shorts, and so on.

In query classification, a category tree can be pre-established, and the query information provided by the user can be assigned to a category within the category tree (e.g., a leaf category). The category tree is a hierarchical tree structure used to organize a large number of product categories in scenarios such as e-commerce. The category tree can be organized as a Directed Acyclic Graph (DAG) T=(C,E), wherein C and E represent the set of all categories and the set of all edges, respectively. Each node represents a category, and an edge between any two nodes indicates a parent-child relationship between these two categories. For example, an edge cᵢ, cⱼ∈C between node cᵢ and node cⱼ indicates that category cᵢ is the parent category of category cⱼ, wherein cᵢ, cⱼ∈C. Each category can have at most one parent category. Each category is further subdivided into one or more subcategories at the next level. This process continues recursively until the final level is reached, where the categories are named leaf categories. For a category cₖ that has no parent, a virtual cᵣₒₒₜ can be added as the parent category in the category tree, with the relevant edge (cᵣₒₒₜ, cₖ) added. Based on the number of hops between each category and cᵣₒₒₜ, all categories can be divided into multiple subsets C^{l}, wherein l represents the l category level. The maximum category level is denoted as L.

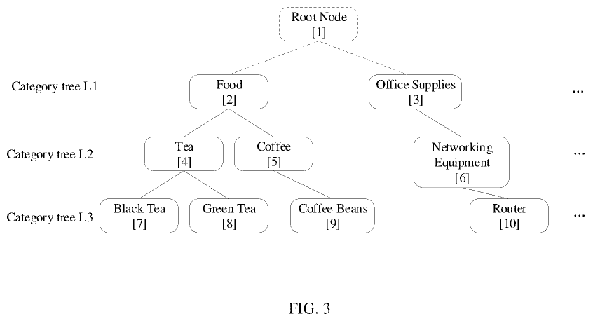

FIG. 3 illustrates an example of a category tree in some embodiments, which includes three category levels (i.e., L=3). The three category levels are referred to as L1, L2, and L3. In this example, the L1 level includes at least the categories “Food” and “Office Supplies.” The L2 level includes at least the categories “Tea,” “Coffee,” and “Networking Equipment,” where “Tea” and “Coffee” are subcategories of the “Food” category in the L1 level, and “Networking Equipment” is a subcategory of the “Office Supplies” category in the L1 level. The L3 level includes at least the categories “Black Tea,” “Green Tea,” “Coffee Beans,” and “Router,” where “Black Tea” and “Green Tea” are subcategories of the “Tea” category in the L2 level, “Coffee Beans” is a subcategory of the “Coffee” category in the L2 level, and “Router” is a subcategory of the “Networking Equipment” category in the L2 level. Due to space limitations, only a category tree with three levels is shown here. It is understood that in actual applications, the category tree may have more or fewer levels, and the categories and their number at each level can be divided according to the specific application scenario. If the query information provided by the user is “Tea” or “Chinese Beverages,” the categories assigned by the server for this query information could include “Black Tea” and “Green Tea.”

Query classification tasks can be viewed as a type of category prediction task. Contrastive learning is a commonly used optimization method for category prediction tasks. It aims to learn feature representations by comparing similar sample pairs with dissimilar sample pairs and improves the quality of the learned representations by learning a distance metric that maps similar samples closer together and dissimilar samples farther apart in the feature space. However, contrastive learning is incompatible with hierarchical tree structures. It is designed to handle flat categories, treating leaf categories as having a “flat” relationship and ignoring the interrelationships between different categories within the category tree.

For example, in the application scenario shown in FIG. 3, when handling the sample “Black Tea,” the samples “Green Tea,” “Coffee,” and “Router” are all considered negative samples relative to “Black Tea.” Traditional contrastive learning would attempt to pull the representation vectors of “Green Tea,” “Coffee,” and “Router” equally far from the representation vector of “Black Tea.” However, “Black Tea” and “Green Tea” are leaf categories under the same parent category “Tea,” and their semantics are very similar, so their representation vectors should be closer to each other. On the other hand, “Black Tea” and “Router” belong to completely unrelated parent categories and have no semantic similarity, so their representation vectors should be farther apart. Traditional contrastive learning cannot achieve this distinction. Consequently, the classification accuracy of contrastive learning in query classification scenarios with a hierarchical tree structure (such as the aforementioned e-commerce scenario) is relatively low.

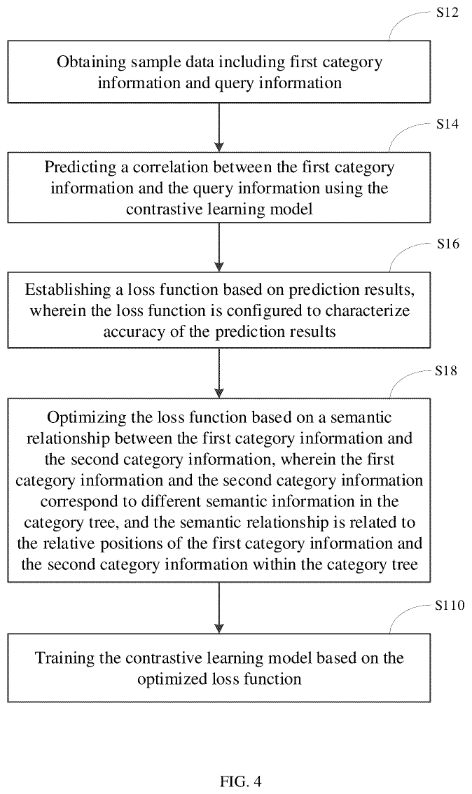

Based on this, the present disclosure provides a training method for a contrastive learning model that uses the hierarchical information of the category tree as prior information to classify the query information provided by the user, thereby improving classification accuracy. As shown in FIG. 4, the training method for the contrastive learning model in the present disclosure includes the following steps:
step S12: obtaining sample data including first category information and query information;
step S14: predicting a correlation between the first category information and the query information using the contrastive learning model;
step S16: establishing a loss function based on prediction results, wherein the loss function is configured to characterize accuracy of the prediction results;
step S18: optimizing the loss function based on a semantic relationship between the first category information and the second category information, wherein the first category information and the second category information correspond to different semantic information in the category tree, and the semantic relationship is related to the relative positions of the first category information and the second category information within the category tree;
step S110: training the contrastive learning model based on the optimized loss function.

In step S12, sample data is obtained, which includes category information corresponding to a node on the category tree. This category information can be represented by the name of the category associated with the node on the category tree. For example, in the embodiment shown in FIG. 3, the category information could be “Tea,” “Coffee,” “Black Tea,” etc. Furthermore, to improve the accuracy of the category information, the first category information may include all the category information along the path from the root node to that category information on the category tree. For instance, referring to FIG. 3, for the category information “Black Tea,” the first category information can be a concatenation of “Food,” “Tea,” and “Black Tea.”

In some embodiments, the sample data also includes the ID corresponding to the category information within the sample data. Each piece of category information can be pre-assigned an ID. After assigning IDs to the various pieces of category information, a mapping relationship can be established between the IDs based on the hierarchical structure of the category tree, thereby determining the parent-child relationships between the various pieces of category information. For example, in the embodiment shown in FIG. 3, assume that the IDs assigned to each piece of category information are as shown in the numbers within square brackets. For instance, the ID assigned to the root node is “1,” the ID assigned to “Food” is “2,” and so on. The mapping relationships can then be established as follows: “1→2→4→7,” “1→2→4→8,” “1→2→5→9,” “1→3→6→10,” etc., indicating that the category information with ID 2 and the category information with ID 3 are both subcategories of the category information with ID 1, the category information with ID 7 and the category information with ID 8 are both subcategories of the category information with ID 4, and so forth. When multiple sample data entries are obtained, the IDs included in each sample data entry can be retrieved, and the aforementioned mapping relationships can be queried based on the retrieved IDs. This allows for the determination of the category level to which the first category information in the multiple sample data entries belongs, the common parent category information of the first category information in the multiple sample data entries, the subcategory information of the first category information in each sample data entry, and other related hierarchical information.

The function cp(,) can be formally defined as follows to map a pair of category information to their nearest common parent category in the category tree:

$$\begin{matrix}cp ( i , j ) = arg max level ( ck ) \\ s . t . reach ( ck , ci ) = 1 , reach ( ck , cj ) = 1\end{matrix} \qquad ( 1 )$$

wherein, level(ck) maps the category information ck to its corresponding category level, i.e., level(ck)=l when ck∈C^{l} is at reach (ck, ci) is a reachability function indicating whether ck can reach ci in the category tree, where 1 denotes true. Max represents the selection of the parent category with the highest level as the common parent category.

The sample data also includes query information, which may include one or more keywords used to describe the object to be queried. The sample data may further include first label information, which characterizes the correlation between the first category information and the query information within the sample data. The first label information can be represented by a binary number; for example, the binary number “0” indicates that the first category information in the sample data is not related to the query information in the sample data, meaning the query information in the sample data does not belong to the category corresponding to the first category information. The binary number “1” indicates that the first category information in the sample data is related to the query information in the sample data, meaning the query information belongs to the category corresponding to the first category information. Taking the embodiment shown in FIG. 3 as an example, suppose the first category information and the query information in a sample data entry are “Green Tea” and “Longjing Tea,” respectively. Since Longjing Tea is a type of Green Tea, the query information in this sample data entry is related to the first category information, and the first label information in this sample data entry would be “1.” If another sample data entry has “Green Tea” as the first category information and “XX Coffee Beans” as the query information, since coffee beans do not belong to the “Green Tea” category, the query information in this sample data entry is not related to the first category information, and the first label information would be “0.”

Typically, query classification tasks are multi-label, multi-class tasks, meaning they involve identifying at least one relevant category from multiple categories for the given query information. The query classification task can be transformed into multiple single-label classification tasks, with each label predicted independently, thereby fully leveraging the category-side information. Taking the embodiment shown in FIG. 3 as an example, for the query information “Longjing Tea,” the relevance of this query information to each of the leaf categories “Black Tea,” “Green Tea,” “Coffee Beans,” and “Router” can be predicted individually. In the sample data obtained during training, each entry may include only one label information and one piece of first category information.

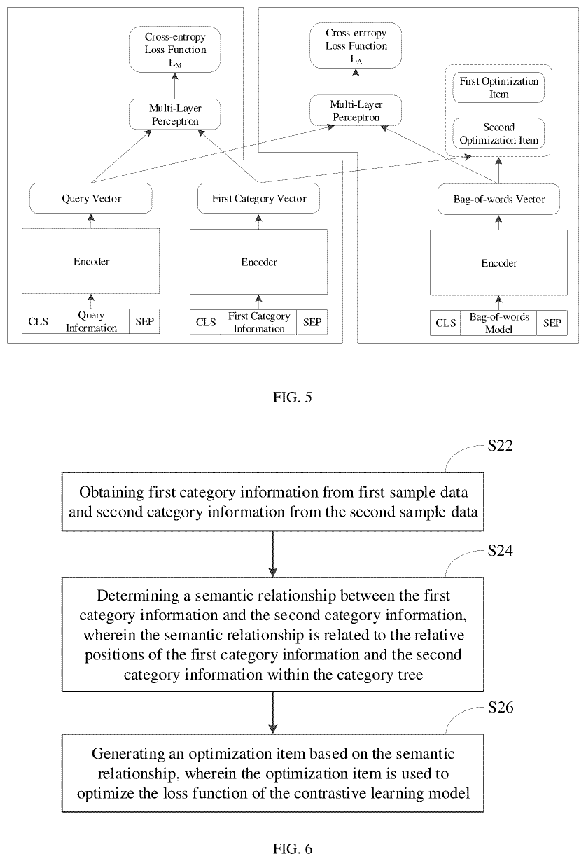

In Step S14, the sample data can be input into the contrastive learning model to be trained, allowing the model to generate a first category vector corresponding to the first category information in the sample data and a query vector corresponding to the query information in the sample data. Referring to FIG. 5, the contrastive learning model may include an encoder, which converts the first category information into a first category vector and the query information into a query vector. During the training process of the contrastive learning model, the parameters of the encoder can be adjusted to generate appropriate first category vectors and query vectors.

After obtaining the first category vector and the query vector, the contrastive learning model can generate a prediction result of the correlation between the query information and the first category information based on these vectors. This prediction result can be represented by second label information. Similar to the first label information, the second label information can be represented by a binary number. Alternatively, the second label information can be a real number between 0 and 1 (a probability value), where a higher probability value indicates a greater likelihood that the contrastive learning model predicts the first category information to be relevant to the query information. The specific representation of the second label information can refer to the representation of the first label information and will not be elaborated here. It is understood that the representation of the first and second label information is not limited to binary numbers. For example, they can also be represented by characters or a combination of numbers and characters. The specific representation method is not restricted by the present disclosure.

The first label information represents the true result of the correlation between the query information and the first category information, while the second label information represents the predicted result of this correlation by the contrastive learning model. Therefore, the difference between the first label information and the second label information can be used to indicate the prediction accuracy of the contrastive learning model. In Step S16, a loss function can be established based on the difference between the first label information and the second label information, such as a cross-entropy loss function. Assuming the first label information is denoted as y and the second label information is denoted as ŷ, the cross-entropy loss function can be expressed as follows:

$${L}_{M} = - y log ( \hat{y} ) - ( 1 - y ) log ( 1 - \hat{y} ) \qquad ( 2 )$$

The contrastive learning model may also include a Multi-Layer Perceptron (MLP), which can take the query vector and the first category vector as inputs to generate the second label information as output. It should be noted that, although multiple encoders are depicted in the diagram, each encoder can share the same network parameters. Additionally, since the query information may include multiple keywords, to facilitate processing by the encoder, these multiple keywords can be combined and included in a CLS (classification) token. This allows the encoder to directly access the keyword combination within the CLS token and encode these keywords as a single unit. Furthermore, an SEP (separator) token can be appended after the query information to indicate the end of the query sequence.

In some embodiments, the sample data also includes a bag-of-words model for the first category information. The contrastive learning model can generate a category vector corresponding to this bag-of-words model (hereinafter referred to as the “bag-of-words vector”) and obtain the predicted result of the correlation between the query information and the first category information based on the query vector and the bag-of-words vector. This prediction result can be represented by third label information. The representation of the third label information can refer to the representation of the first label information and will not be elaborated on here. In the same sample data, the bag-of-words model and the first category information are used to represent the same category through different representation methods. In query classification tasks, the query information input by the user is often very short, and the amount of information contained in this query is limited. By including a bag-of-words model in the sample data, an augmented sample of the first category information can be constructed, providing more comprehensive category information. This enables the contrastive learning model to extract more useful information, thereby further improving the classification accuracy of the model.

The first label information represents the true result of the correlation between the query information and the first category information. Since the bag-of-words model and the first category information represent the same category using different representation methods, the third label information is also used to indicate the predicted result of the correlation between the query information and the first category information by the contrastive learning model. Therefore, the difference between the first label information and the third label information can be used to indicate the prediction accuracy of the contrastive learning model. After obtaining the third label information, another loss function, denoted as LA, can be generated based on the third label information and the first label information. This loss function can also be a cross-entropy loss function, and its specific representation can refer to Equation (2).

The following is an illustrative example of how to generate a bag-of-words model. One or more product titles under the first category information can be obtained, where each title includes at least one word. The word frequency of each word in the one or more product titles is then determined. Based on the word frequencies, at least one target word is identified from the set of words, and the bag-of-words model for the first category information is generated based on these target words.

At least one product under the first category information can be a product with a high search rate, click-through rate, or purchase rate (ranked in the top k1) within a historical time period. For example, suppose the first category information is “Router,” a title of a product under this category could be “Router 4A Gigabit Edition Dual-Core CPU Dual Gigabit 1200M Dual-Band Wireless Speed 5G Home Smart Router.” This title can be processed using word segmentation to obtain one or more words, and the word frequency of each word can be determined. The word frequency can be represented by the TF-IDF (Term Frequency-Inverse Document Frequency) value of the word. Then, a certain number of words with the highest frequencies (top k2) can be selected as target words. These target words are concatenated to form the bag-of-words model for the first category information. Furthermore, since the length of the input information to the model has an upper limit (denoted as m), the concatenated target words can be truncated to a length less than or equal to m. The truncated and concatenated target words then constitute the bag-of-words model for the first category information.

The above embodiment provides an illustrative example of generating a bag-of-words model. It should be understood that this is merely an exemplary explanation and is not intended to limit the present disclosure. For instance, in other embodiments, an n-gram model of the first category information can also be used as the bag-of-words model for the first category information. Alternatively, the first category information can be split into individual strokes, and the bag-of-words model for the first category information can be generated based on the resulting stroke sequences.

Since the first category information is textual, any addition, deletion, or alteration of some of its characters can easily lead to a meaning that is significantly different from the original text. Therefore, constructing augmented samples for textual information is challenging. In the embodiments of the present disclosure, the bag-of-words model and the first category information represent the same category using different methods. This approach successfully creates an augmented sample of the first category information, thereby addressing the aforementioned challenge.

Traditional contrastive learning only utilizes leaf categories and organizes them in a flat list. Taking the category tree shown in FIG. 3 as an example, when the category “Black Tea” is used as the anchor sample, the loss function in the related art attempts to equally distance the category vectors corresponding to other leaf categories, such as “Green Tea,” “Coffee Beans,” and “Router,” from the category vector corresponding to “Black Tea.” However, “Black Tea” and “Green Tea” are subcategories under the common parent category “Tea” in the second category level, indicating that they share the same semantics as “Tea.” In contrast, there is less common semantic similarity between “Black Tea” and “Coffee Beans,” and there is no common semantic similarity between “Black Tea” and “Router,” as they do not share a common parent category at the higher category level. Despite the differing semantic similarities between these categories, the loss function in the related art attempts to equally reduce the similarity scores of their category vectors. This may ultimately disrupt the general semantic relationships, such as causing the category vectors corresponding to “Green Tea” and “Router” to be equally distant from the category vector corresponding to “Black Tea.” The inventors of the present disclosure recognized that a reasonable contrastive loss function should preserve the common semantic components between categories while simultaneously distinguishing the differences between different categories.

Based on this, in Step S18, the loss function can be optimized based on the semantic relationship between the first category information and the second category information within the category tree where the first category information is located. The second category information can be the category information from another sample data entry. The semantic relationship between the first category information and the second category information is related to their relative positions in the category tree. This relative positional relationship includes the respective category levels of the first and second category information, as well as the parent-child relationship between the first and second category information.

For example, when the first category information and the second category information are at the same category level, if they belong to the same parent category, the distance between the first category vector corresponding to the first category information and the second category vector corresponding to the second category information should be reduced. If they belong to different parent categories, the distance between the first category vector and the second category vector should be increased. Additionally, if there is a parent-child relationship between the first category information and the second category information, there is likely common semantic information between them, and their category vectors should be aligned accordingly. On the other hand, if there is no parent-child relationship between the first and second category information, there is no shared semantic information, and their category vectors should be distanced from each other.

Optimization items can be established based on the semantic relationship between the first category information and the second category information within the category tree wherein the first category information is located. These optimization items can then be used to optimize the loss function obtained in Step S16. Specifically, the optimization items may include at least one of a first optimization item and a second optimization item. The first optimization item is also referred to as Local Hierarchical Contrastive Loss (LHCL), while the second optimization item is referred to as Global Hierarchical Contrastive Loss (GHCL). LHCL modifies the original formulation of the loss function by introducing the common parent category of the categories being compared. LHCL encourages the model to capture the semantic relationships between categories, thereby producing more meaningful representations (i.e., category vectors) that are consistent with the hierarchical structure of the tree. The effectiveness of LHCL relies on the assumption that the representation of a common parent category should be equivalent to the general semantics of its child categories. GHCL ensures this assumption by aligning the semantic representations across category levels. By adopting these two optimization items, the common semantic components between categories and subcategories are preserved, preventing the disruption of general semantic information during the representation learning process. Referring to FIG. 5, the specific implementation of these two optimization items can be explained as follows:

### First Optimization Item

The common parent category information of the first category information and the second category information within the category tree can be obtained. Then, the first non-overlapping semantics between the first category information and the common parent category information, as well as the second non-overlapping semantics between the second category information and the common parent category information, can be obtained. The first optimization item is then obtained based on the first non-overlapping semantics and the second non-overlapping semantics.

Assume that both the first category information and the second category information belong to the l-th category level in the category tree, denoted as ci and cj, respectively. The common parent category information of the first category information and the second category information belongs to the k-th category level, denoted as ck, wherein, ck could belong to the l−1-th category level or any category level prior to the l−1-th category level. Taking the category tree shown in FIG. 3 as an example, if the aforementioned two category information items are “black tea” and “green tea,” their common parent category information would be “tea.” If the two category information items are “black tea” and “coffee beans,” their common parent category information would be “food.” Assume that the aforementioned two category information items are “black tea” and “router,” then their common parent category information would be the “root node.” It should be noted that the common parent category information here refers to the parent category information located in the category level closest to the category levels where the aforementioned two category information items reside. For instance, when the aforementioned two category information items are “black tea” and “green tea,” the categories “tea,” “food,” and “root node” all serve as parent category information for these two items. However, since “tea” is located in the adjacent category level to the category levels where the two pieces of category information are situated, it is closer in hierarchy compared to the category levels where “food” and the “root node” are located. Therefore, “tea” can be designated as the common parent category information for these two category information items.

The second category vector corresponding to the second category information, generated by the contrastive learning model, as well as the third category vector corresponding to the common parent category information, can be obtained. The first non-overlapping semantics can be derived based on the first difference vector between the first category vector and the third category vector. Similarly, the second non-overlapping semantics can be derived based on the second difference vector between the second category vector and the third category vector. Assume that the first category information and the second category information are “black tea” and “green tea,” respectively, with their common parent category information being “tea.” In this case, the first category vector corresponding to “black tea” (denoted as X1) and the third category vector corresponding to “tea” (denoted as Y) can be obtained, resulting in the first difference vector (denoted as Δ). Similarly, the second category vector corresponding to “green tea” (denoted as X2) and the category vector Y corresponding to “tea” can be obtained, resulting in the second difference vector (denoted as Δ). The first difference vector Δ1 can represent the first non-overlapping semantics, while the second difference vector Δ2 can represent the second non-overlapping semantics.

When obtaining the first optimization item, the first similarity between the first difference vector and the second difference vector can be calculated. Additionally, the second similarity between the first category vector and the category vector corresponding to the bag-of-words model of the first category information can be determined. The first optimization item is then derived based on the first similarity and the second similarity.

The method for obtaining the bag-of-words model can be referred to in the previous embodiments and will not be reiterated here. In this context, since the bag-of-words model and the first category information represent the same category, they can be treated as a pair of positive samples. On the other hand, since the first category information and the second category information represent different categories, they can be treated as a pair of negative samples. The optimization items can be determined based on the ratio of the second similarity to the first similarity. The first similarity can be represented by the cosine distance or other distance measures between the first difference vector and the second difference vector. The specific calculation method is as follows:

$${s}_{HC} ( {h}_{ci} , {h}_{cj} ) = \frac{{( {h}_{ci} - {h}_{ck} )}^{T} ( {h}_{cj} - {h}_{ck} )}{‖ {h}_{ci} - {h}_{ck} ‖ ‖ {h}_{cj} - {h}_{ck} ‖} \qquad ( 3 )$$

h_{ci} and h_{cj} represent the first category vector corresponding to the first category information ci and the second category vector corresponding to the second category information cj, respectively. h_{ck} represents the third category vector corresponding to the common parent category information of the first and second category information. The denominator part indicates the normalization process. The method for obtaining the second similarity is similar to that of the first similarity and will not be reiterated here.

After obtaining the first similarity and the second similarity, the first optimization item can be derived based on the following method:

$${Loss}_{LHCL} = - {\sum }_{batch} log \frac{exp ( {s}_{HC} ( {h}_{ci} , {h}_{ci '} ) / τ )}{{\sum }_{j ∈ batch} exp ( {s}_{HC} ( {h}_{ci} , {h}_{cj} ) / τ )} \qquad ( 4 )$$

batch represents a batch of sample data, h_{ci′} represents the category vector corresponding to the bag-of-words model ci′ of the first category information, and t denotes the temperature parameter. The summation symbol Σ in the denominator indicates the summation of the first similarity between the first category information and any different second category information within the same batch of sample data.

In the above embodiment, by subtracting the category vector corresponding to the parent category information from the category vector corresponding to the category information, the overlapping semantic parts between the category information and its parent category information can be filtered out. This allows for comparing only the non-overlapping semantic parts between different category information and their common parent category information during similarity comparison, thereby maximizing the differences between the non-overlapping semantic parts as much as possible. These non-overlapping semantic parts are decoupled with the help of the category tree and vary according to the relative positions of the two pieces of category information.

For category information that does not have a common parent category (e.g., “food” and “office supplies” in FIG. 3), a virtual root node can be created and used as their common parent category. The category vector for the root node can be set to a zero vector, so that when all the category information is flat (non-hierarchical), the loss function before optimization is the same as the loss function after optimization. Therefore, the optimized loss function can be considered a general form of the pre-optimization loss function, compatible with any hierarchical or flat category structure.

### Second Optimization Item

At least one first target category information that has a parent-child relationship with the first category information within the second category information can be identified, as well as at least one second target category information within the second category information that does not have a parent-child relationship with the first category information. The second optimization item is then established based on the third similarity between the first category information and each of the first target category information, as well as the fourth similarity between the first category information and each of the second target category information. The purpose of the second optimization item is to ensure that the semantic similarity between the first category information and at least one first target category information is greater than the semantic similarity between the first category information and at least one second target category information.

Specifically, the contrastive learning model can generate the first category vector corresponding to the first category information, the first target category vector corresponding to each of the at least one first target category information, and the second target category vector corresponding to each of the at least one second target category information. Then, the first average vector of all first target category vectors and the second average vector of all second target category vectors can be obtained. The similarity between the first category vector and the first average vector can be used as the third similarity, while the similarity between the first category vector and the second average vector can be used as the fourth similarity.

Referring again to FIG. 3, assume that the first category information is “tea.” The first target category information would include “black tea” and “green tea,” while the second target category information would include “coffee beans” and “router.” Therefore, the first target vector Z11 corresponding to “black tea” and the first target vector Z12 corresponding to “green tea” can be obtained, and the first average vector Z1 of these two first target vectors Z11 and Z12 can be calculated. Similarly, the first target vector Z21 corresponding to “coffee beans” and the first target vector Z22 corresponding to “router” can be obtained, and the second average vector Z2 of these two second target vectors Z21 and Z22 can be calculated. Then, the similarity between the first category vector corresponding to “tea” and the first average vector Z1 is determined as the third similarity, and the similarity between the first category vector corresponding to “tea” and the second average vector Z2 is determined as the fourth similarity.

The third similarity reflects the similarity between a category information and its subcategory information. Since category information with a parent-child relationship shares common semantic information, the third similarity can be increased to preserve the shared semantic information between the category information and its subcategory information. On the other hand, there is less shared semantic information between category information that does not have a parent-child relationship, so the fourth similarity can be decreased to distance the category vectors corresponding to category information without a parent-child relationship. The second optimization item can be obtained based on the ratio of the third similarity to the fourth similarity, as detailed below:

$${loss}_{GHCL}^{l} = - {\sum }_{ci ∈ {C}^{l}} log \frac{exp ( s ( {h}_{ci} , {h}_{{ci}^{child}} ) / τ )}{exp ( s ( {h}_{ci} , {h}_{{ci}^{\overline{child}}} ) / τ )} \qquad ( 5 )$$

$$wherein :$$

$$\begin{matrix}{h}_{{ci}^{child}} = avg ( \{ {h}_{cj} \vert ( ci , cj ) ∈ E \} ) \\ {h}_{{ci}^{\overline{child}}} = avg ( \{ {h}_{cj} \vert ( ci , cj ) ∉ E \} )\end{matrix} \qquad ( 6 )$$

In the equation, (ci, cj)∈E indicates that the first category information ci and the second category information cj are connected by an edge E, meaning they have a parent-child relationship. (ci, cj)∉E indicates that the first category information ci and the second category information cj do not have a parent-child relationship. The term avg represents the averaging of the second category vectors h_{cj} corresponding to each second category information cj. The vectors h_{ci}_{^{child}} and h_{ci}_{^{c̅h̅i̅l̅d̅}} represent the first average vector and the second average vector, respectively. The term s denotes the similarity between two vectors, which can be expressed using cosine distance or other distance measures. C^{l} represents the l-th category level.

The above equation (4) represents the second optimization item for the l-th category level. By summing the second optimization items across all category levels, the total second optimization item can be obtained, which can then be used to optimize the loss function. The total second optimization item can be denoted as:

$${Loss}_{GHCL} = {\sum }_{l} {loss}_{GHCL}^{l} \qquad ( 7 )$$

The average vector of all sibling category information belonging to the same parent category information represents the filtered-out unique semantic components of each category information while retaining the common semantic components. Utilizing this characteristic, GHCL aligns the category vector corresponding to the category information with the common semantics of its subcategory information level by level, while pushing the category vectors corresponding to different category information at the same level far apart on a global scale. Under the influence of GHCL, LHCL can distinguish between the common semantics and unique semantics of any two pieces of category information.

After obtaining the optimization items and the loss function, these optimization items and the loss function can be weighted to derive the optimized loss function. For example, assuming the loss function includes the aforementioned LM and LA, the optimized loss function L can be expressed as:

$$L = {L}_{M} + {λ}_{1} {L}_{A} + {λ}_{2} {Loss}_{LHCL} + {λ}_{3} {Loss}_{GHCL} \qquad ( 8 )$$

wherein, λ₁, λ₂ and λ₃ are all hyperparameters that can be set based on empirical values.

In step S110, the contrastive learning model can be trained using the optimized loss function. Since the optimization process utilizes the relative position relationships of different category information within the category tree, the category vectors generated by the trained contrastive learning model for different category information will be able to represent the relative positions of the corresponding category information within the category tree. For example, the distance between the category vectors corresponding to two subcategories belonging to the same parent category information will be closer, while the distance between the category vectors corresponding to two subcategories that do not share the same parent category information will be farther. Additionally, the distance between the category vector corresponding to a category information and its subcategory information will be smaller than the distance between the category vector corresponding to the same category information and a non-subcategory information.

It should be noted that the optimization items can be obtained through an optimization module. The optimization module can function as a plugin module, which is only required during the training process. After the contrastive learning model has been trained, the original model structure can be used for inference. In this way, during the inference phase, there is no need to alter the original model structure or increase the complexity of the contrastive learning model. This ensures that no additional processing complexity or time consumption is introduced during the inference phase.

Referring to FIG. 6, the present disclosure also provides a method for acquiring an optimization item, which is used to acquire the optimization item in any of the aforementioned training methods. The method includes:
step S22: obtaining first category information from first sample data and second category information from second sample data;
step S24: determining a semantic relationship between the first category information and the second category information, wherein the semantic relationship is related to the relative positions of the first category information and the second category information within the category tree;
step S26: generating an optimization item based on the semantic relationship, wherein the optimization item is used to optimize the loss function of the contrastive learning model.

The specific details of the embodiments of the present disclosure can be found in the previously described embodiments of the training method. For the sake of brevity, they will not be reiterated here.

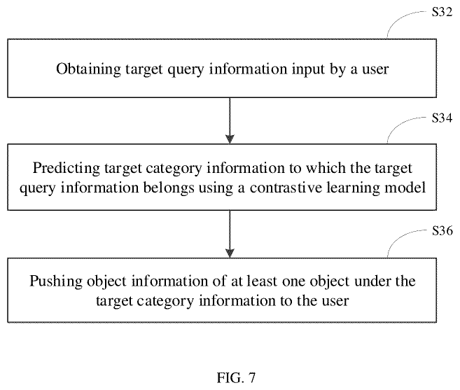

Referring to FIG. 7, the present disclosure also provides an information pushing method, which includes:
step S32: obtaining target query information input by a user;
step S34: predicting target category information to which the target query information belongs using a contrastive learning model, wherein the contrastive learning model is trained using the training method described in any embodiment of the present disclosure;
step S36: pushing object information of at least one object under the target category information to the user.

In step S32, the user can input the target query information through a client or a web interface. For example, in the case of a client application, the client can provide a user interface where the user can edit or select the target query information. In a practical application scenario, such as an e-commerce client, the user can input the name or characteristics of the product they wish to purchase on the user interface of the e-commerce client. The name or characteristics of the product would then serve as the target query information.

In step S34, the contrastive learning model can output at least one target category information associated with the target query information. For example, if the user inputs the target query information “notebook,” the target category information may include both “laptop” and “paper notebook.” The contrastive learning model can be trained based on any of the previously described embodiments, and the specific training method is not reiterated in this embodiment.

In step S36, the object information of at least one object under the target category information can be pushed to the user. Continuing with the aforementioned e-commerce scenario, after the user inputs the target query information on the e-commerce client, the e-commerce client can send the target query information to the e-commerce server. The e-commerce server, where the contrastive learning model is deployed, can predict the target category information associated with the target query information and push the product information of at least one product under the target category information to the user's e-commerce client for display. By performing category prediction, the system can accurately understand the user's intent, thereby retrieving and displaying product information that is strongly related to the user's intent, ultimately increasing the click-through rate and conversion rate for the user.

The present disclosure also provides a computer-readable storage medium on which computer instructions are stored. When executed by a processor, these computer instructions implement the addressing method described in any embodiment of the present disclosure. The computer-readable storage medium can be phase-change memory (PRAM), static random-access memory (SRAM), dynamic random-access memory (DRAM), other types of random-access memory (RAM), read-only memory (ROM), electrically erasable programmable read-only memory (EEPROM), flash memory, or other memory technologies, compact disc read-only memory (CD-ROM), digital versatile discs (DVD) or other optical storage, magnetic tape cassettes, magnetic tape magnetic disk storage, or other magnetic storage devices, or any other non-transitory medium that can be used to store information accessible by a computing device.

From the above description of the embodiments, it can be understood that the embodiments of the present disclosure can be implemented by means of software combined with the necessary general hardware platform. Based on this understanding, the technical solutions of the embodiments of the present disclosure, or at least the parts contributing to the prior art, can be embodied in the form of a software product. This computer software product can be stored in a storage medium, such as ROM/RAM, magnetic disks, optical disks, etc., and includes several instructions to enable a computer device (which can be a personal computer, server, network device, or the like) to execute the methods described in various embodiments of the present disclosure or in certain parts of these embodiments.

The systems, devices, modules, or units described in the above embodiments can be specifically implemented by a computer device or entity, or by a product with certain functionalities. A typical implementation device is a computer, which can take various forms, such as a personal computer, laptop, cellular phone, camera phone, smartphone, personal digital assistant, media player, navigation device, email communication device, game console, tablet computer, wearable device, or a combination of any of these devices.

The various embodiments in this disclosure are described in a progressive manner, with similar or identical parts in different embodiments referencing each other, while the emphasis in each embodiment is on the differences from other embodiments. Particularly for the device embodiments, since they are essentially similar to the method embodiments, the descriptions are relatively brief, and relevant details can be found in the descriptions of the method embodiments. The device embodiments described above are merely illustrative. The modules described as separate components may or may not be physically separated; in implementing the solutions of the embodiments of this disclosure, the functions of the various modules can be realized in one or multiple software and/or hardware components. It is also possible to select some or all of the modules based on actual needs to achieve the objectives of this embodiment. Those skilled in the art can understand and implement this without undue creative effort.

The above descriptions are merely specific embodiments of the present disclosure. It should be noted that those of ordinary skill in the art may make several improvements and modifications without departing from the principles of the disclosed embodiments, and these improvements and modifications should also be considered within the scope of protection of the disclosed embodiments.

What is claimed is:

1. A method for training a contrastive learning model, the method comprising:
obtaining sample data including first category information and query information;
predicting a correlation between the first category information and the query information using the contrastive learning model;
establishing a loss function based on prediction results, wherein the loss function is configured to characterize accuracy of the prediction results;
optimizing the loss function based on a semantic relationship between the first category information and second category information, wherein the first category information and the second category information correspond to different semantic information in a category tree, and the semantic relationship is related to relative positions of the first category information and the second category information within the category tree;
training the contrastive learning model based on the optimized loss function.

2. The method according to claim 1, wherein predicting the correlation between the first category information and the query information using the contrastive learning model comprises:
obtaining a first category vector corresponding to the first category information and a query vector corresponding to the query information using the contrastive learning model;
predicting the correlation between the first category information and the query information based on the first category vector and the query vector.

3. The method according to claim 1, wherein the second category information includes category information in the same category level as the first category information within the category tree; and wherein optimizing the loss function based on the semantic relationship between the first category information and the second category information comprises:
obtaining common parent category information of the first category information and the second category information within the category tree;
obtaining first non-overlapping semantics between the first category information and the common parent category information, and second non-overlapping semantics between the second category information and the common parent category information;
obtaining a first optimization item based on the first non-overlapping semantics and the second non-overlapping semantics;
optimizing the loss function based on the first optimization item.

4. The method according to claim 3, wherein obtaining the first non-overlapping semantics between the first category information and the common parent category information, and the second non-overlapping semantics between the second category information and the common parent category information comprises:
obtaining a first category vector corresponding to the first category information, a second category vector corresponding to the second category information, and a third category vector corresponding to the common parent category information, all generated by the contrastive learning model;
obtaining the first non-overlapping semantics based on a first difference vector between the first category vector and the third category vector, and obtaining the second non-overlapping semantics based on a second difference vector between the second category vector and the third category vector.

5. The method according to claim 4, wherein obtaining the first optimization item based on the first non-overlapping semantics and the second non-overlapping semantics comprises:
obtaining a first similarity between the first difference vector and the second difference vector;
obtaining a second similarity between the first category vector and a category vector corresponding to a bag-of-words model of the first category information;
obtaining the first optimization item based on the first similarity and the second similarity.

6. The method according to claim 5, further comprising:
obtaining a title of at least one product under the first category information, wherein the title includes at least one word;
obtaining a word frequency for each word in the title of the at least one product;
determining at least one target word from the at least one word based on their respective word frequencies;
generating a bag-of-words model of the first category information based on the at least one target word.

7. The method according to claim 1, wherein the second category information corresponds to a category level that is one level lower than the category level of the first category information within the category tree; and wherein optimizing the loss function based on the semantic relationship between the first category information and the second category information within the category tree comprises:
obtaining at least one first target category information from the second category information that has a parent-child relationship with the first category information, and at least one second target category information from the second category information that does not have a parent-child relationship with the first category information;
optimizing the loss function to ensure that semantic similarity between the first category information and the at least one first target category information is greater than semantic similarity between the first category information and the at least one second target category information.

8. The method according to claim 7, wherein optimizing the loss function to ensure that the semantic similarity between the first category information and the at least one first target category information is greater than the semantic similarity between the first category information and the at least one second target category information comprises:
obtaining a first category vector corresponding to the first category information, a first target category vector corresponding to each of the at least one first target category information, and a second target category vector corresponding to each of the at least one second target category information, all generated by the contrastive learning model;
obtaining a first average vector for the first target category vectors and a second average vector for the second target category vectors;
optimizing the loss function to ensure that a third similarity between the first category vector and the first average vector is greater than a fourth similarity between the first category vector and the second average vector.

9. The method according to claim 1, wherein optimizing the loss function based on the semantic relationship between the first category information and the second category information within the category tree comprises:
establishing an optimization item based on the semantic relationship between the first category information and the second category information within the category tree;
applying a weighted process to the optimization item and the loss function to obtain the optimized loss function.

10. The method according to claim 2, wherein the sample data further includes first label information, which is used to characterize the correlation between the first category information and the query information; and wherein predicting the correlation between the first category information and the query information based on the first category vector and the query vector comprises:
obtaining second label information predicted by the contrastive learning model based on the query vector and the first category vector;
obtaining third label information predicted by the contrastive learning model based on the category vector corresponding to a bag-of-words model of the first category information and the first category vector, after generating the category vector corresponding to the bag-of-words model of the first category information;
wherein establishing the loss function based on the prediction results comprises:
establishing a first loss function based on the first label information and the second label information, and establishing a second loss function based on the first label information and the third label information.

11. An information pushing method, the method comprising:
obtaining target query information input by a user;
predicting target category information to which the target query information belongs using a contrastive learning model trained using the method according to claim 1;
pushing object information of at least one object under the target category information to the user.

12. A non-transitory computer-readable storage medium configured with instructions executable by one or more processors to cause the one or more processors to perform operations comprising:
obtaining sample data including first category information and query information;
predicting a correlation between the first category information and the query information using the contrastive learning model;
establishing a loss function based on prediction results, wherein the loss function is configured to characterize accuracy of the prediction results;
optimizing the loss function based on a semantic relationship between the first category information and second category information, wherein the first category information and the second category information correspond to different semantic information in a category tree, and the semantic relationship is related to relative positions of the first category information and the second category information within the category tree;
training the contrastive learning model based on the optimized loss function.

13. The non-transitory computer-readable storage medium according to claim 12, wherein predicting the correlation between the first category information and the query information using the contrastive learning model comprises:
obtaining a first category vector corresponding to the first category information and a query vector corresponding to the query information using the contrastive learning model;
predicting the correlation between the first category information and the query information based on the first category vector and the query vector.

14. The non-transitory computer-readable storage medium according to claim 12, wherein the second category information includes category information in the same category level as the first category information within the category tree; and wherein optimizing the loss function based on the semantic relationship between the first category information and the second category information comprises:
obtaining common parent category information of the first category information and the second category information within the category tree;
obtaining first non-overlapping semantics between the first category information and the common parent category information, and second non-overlapping semantics between the second category information and the common parent category information;
obtaining a first optimization item based on the first non-overlapping semantics and the second non-overlapping semantics;
optimizing the loss function based on the first optimization item.

15. The non-transitory computer-readable storage medium according to claim 14, wherein obtaining the first non-overlapping semantics between the first category information and the common parent category information, and the second non-overlapping semantics between the second category information and the common parent category information comprises:
obtaining a first category vector corresponding to the first category information, a second category vector corresponding to the second category information, and a third category vector corresponding to the common parent category information, all generated by the contrastive learning model;
obtaining the first non-overlapping semantics based on a first difference vector between the first category vector and the third category vector, and obtaining the second non-overlapping semantics based on a second difference vector between the second category vector and the third category vector.

16. The non-transitory computer-readable storage medium according to claim 15, wherein obtaining the first optimization item based on the first non-overlapping semantics and the second non-overlapping semantics comprises:
obtaining a first similarity between the first difference vector and the second difference vector;
obtaining a second similarity between the first category vector and a category vector corresponding to a bag-of-words model of the first category information;
obtaining the first optimization item based on the first similarity and the second similarity.

17. The non-transitory computer-readable storage medium according to claim 16, wherein the operations further comprise:
obtaining a title of at least one product under the first category information, wherein the title includes at least one word;
obtaining a word frequency for each word in the title of the at least one product;
determining at least one target word from the at least one word based on their respective word frequencies;
generating a bag-of-words model of the first category information based on the at least one target word.

18. The non-transitory computer-readable storage medium according to claim 12, wherein the second category information corresponds to a category level that is one level lower than the category level of the first category information within the category tree; and wherein optimizing the loss function based on the semantic relationship between the first category information and the second category information within the category tree comprises:
obtaining at least one first target category information from the second category information that has a parent-child relationship with the first category information, and at least one second target category information from the second category information that does not have a parent-child relationship with the first category information;
optimizing the loss function to ensure that semantic similarity between the first category information and the at least one first target category information is greater than semantic similarity between the first category information and the at least one second target category information.

19. The non-transitory computer-readable storage medium according to claim 12, wherein optimizing the loss function based on the semantic relationship between the first category information and the second category information within the category tree comprises:
establishing an optimization item based on the semantic relationship between the first category information and the second category information within the category tree;
applying a weighted process to the optimization item and the loss function to obtain the optimized loss function.

20. A computer device, comprising:
one or more processors; and
one or more computer-readable memories coupled to the one or more processors and having instructions stored thereon that are executable by the one or more processors to perform one or more operations comprising:
obtaining sample data including first category information and query information;
predicting a correlation between the first category information and the query information using the contrastive learning model;
establishing a loss function based on prediction results, wherein the loss function is configured to characterize accuracy of the prediction results;
optimizing the loss function based on a semantic relationship between the first category information and second category information, wherein the first category information and the second category information correspond to different semantic information in a category tree, and the semantic relationship is related to relative positions of the first category information and the second category information within the category tree;
training the contrastive learning model based on the optimized loss function.
